(19) United States
(12) Patent Application Publication
(10) Pub. No.: US 2008/0194394 A1
(43) Pub. Date: Aug. 14, 2008

(54) Glass Substrates for Flat Screens

(75) Inventor: Emmanuel Lecomte, Bobigny (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 11/914,511

(22) PCT Filed: May 18, 2006
(86) PCT No.: PCT/FR06/50459

§ 371 Date: Nov. 15, 2007

(30) Foreign Application Priority Data
May 27, 2005 (FR) 0551390

(51) Int. Cl. C03C 3/093; C03C 3/091; C03B 18/02

(52) U.S. Cl. 501/67; 501/66; 65/99.2

(57) ABSTRACT

The invention relates to a glass substrate whose chemical composition comprises the following components within limits defined thereafter and expressed in percentages by weight: 58-72% by weight SiO₂, 0.8-3 by weight TiO₂, 2-15 by weight B₂O₃, 10-25 by weight Al₂O₃, 5-12 by weight CaO, 0-3 by weight MgO, 0-6 by weight BaO, 0-4 by weight SrO, 0-3 by weight ZnO, and 0-1 by weight R₂O.

The present invention relates to glass substrates capable of being used for manufacturing flat screens and having compositions of the aluminosilicate type containing low contents of alkali metal oxides.

Flat screens may be produced by various technologies, among which the main ones are PDP (Plasma Display Panel) and LCD (Liquid Crystal Display) technologies. These two technologies require the use of glass substrates, but impose extremely different properties on these substrates, so that their chemical composition must be specifically adapted to each of them.

LCD technology uses manufacturing processes in which thin glass sheets are used as substrates for the deposition of thin-film transistors via techniques used in the electronics semiconductor industry, among which are the techniques of high-temperature deposition, photolithography and chemical etching. Numerous requirements in terms of the glass properties ensue from these processes, especially as regards their mechanical, chemical and thermal resistance.

Considering the high temperatures used for depositing thin films of silicon, the thermal stability of the glass is of prime importance for avoiding any deformation. A lower annealing temperature of at least 600° C. and even 650° C. is thus required. This temperature is commonly called the “strain point” and corresponds to the temperature at which glass has a viscosity equal to 10^{14.5} poise. A low expansion coefficient is also required to avoid too high a variation in the dimensions of the glass substrate as a function of temperature. A good agreement between the expansion coefficient of the silicon and that of the glass is however essential for avoiding the generation of mechanical stresses between the glass and the silicon. The expansion coefficient of the glass substrate must therefore be between 25 and 35×10⁻⁷/° C., measured in the temperature range 25-300° C.

The chemical attack used for etching the silicon must not degrade the glass substrate, and especially its surface. As these attacks are carried out by acids, it is essential that the glass substrate has a very high resistance to acid corrosion.

Considering the constant increase in the size of flat screens, it is also important that the weight of the substrate be minimized, which, for the glass used, translates into a demand for low density. The low density, in the same way as the Young's modulus, also plays a role in preventing the bowing of large-sized substrates and thus in facilitating the handling of said substrates during all the steps of the process for manufacturing the screens.

Certain properties of the glass are also important as regards the industrial feasibility of the glass substrates. In particular, a high-temperature viscosity that is too high would have economic consequences as it would increase the energy expenditure and decrease the lifetime of the glass-melting furnaces. It is also essential that the glass does not devitrify at too high a temperature (the liquidus temperature must therefore be limited) and/or with high crystallization rates, as that would destroy the feasibility of forming flat glass sheets.

Compositions that partially correspond to this specification are known in Patent Applications WO 00/32528 and US 2004/43887 and are mainly composed of silica (SiO₂), alumina (Al₂O₃), boron oxide (B₂O₃) and calcium oxide (CaO). These glasses are free from alkali metal oxides and comprise low amounts of, and advantageously no, divalent oxides other than calcium oxide. The Young's modulus values obtained are however insufficient and range from 60 to 70 GPa.

The object of the present invention is to improve the compositions described in the aforementioned documents by increasing their Young's modulus, while retaining the good properties in terms of density, thermal stability and expansion coefficient. Another object of the invention is to provide economic compositions in terms of the cost resulting from the raw materials and the amount of energy to be supplied for manufacturing the glass substrates.

One subject of the invention is a glass substrate having a chemical composition comprising the following constituents within the limits defined hereinbelow, expressed as weight percentages:

| | |
|---|---|
| SiO₂ | 58 to 72; |
| TiO₂ | 0.8 to 3; |
| B₂O₃ | 2 to 15; |
| Al₂O₃ | 10 to 25; |
| CaO | 5 to 12; |
| MgO | 0 to 3; |
| BaO | 0 to 6; |
| SrO | 0 to 4; |
| ZnO | 0 to 3; and |
| R₂O | 0 to 1, |

R₂O denoting alkali metal oxides (mainly sodium, potassium and lithium oxides).

Silica (SiO₂) is an essential component of the vast majority of industrial glass. It is a glass network former component, which influences all the properties of the glass. Too low an amount of silica (below 58%) would result, simultaneously, in degradation of the stability of the glass with respect to devitrification, too low a resistance to acid corrosion, too high a density and too high an expansion coefficient. It is preferred that the silica content be greater than or equal to 60%, or 62% and even 63%. On the other hand, contents that are too high (above 72%) have, as a result, an unacceptable increase in the viscosity, making the glass melting process difficult. The silica content of the glasses according to the invention is therefore advantageously less than or equal to 70%, or 68% and even 66%.

Titanium oxide (TiO₂) is an essential component of the composition of the glass substrates according to the present invention. The inventors have demonstrated the strong influence of this oxide on the increase in Young's modulus. Even though this influence begins to be felt for values of 0.8%, contents above 1%, or even greater than or equal to 1.2% are preferred. Contents that are too high lead, on the other hand, to a decrease of the light transmission of the glass, accompanied by unacceptable yellowing. The content of titanium oxide must therefore be less than or equal to 3%, and advantageously less than or equal to 2%. The addition of a very small amount of cobalt oxide (CoO), advantageously of around 5 to 50 ppm, especially from 10 to 20 ppm, may help to reduce the yellowing. Patent U.S. Pat. No. 5,851,939 describes glass compositions that are rich in strontium oxide, low in calcium oxide and that contain titanium oxide to improve the acid resistance, but does not describe the positive influence of this oxide on the increase in Young's modulus.

Boron oxide (B₂O₃) is also a network former component, which helps to reduce the liquidus temperature, the density and the expansion coefficient. It also has the advantage over silica of reducing the high-temperature viscosity and therefore of facilitating glass melting. The glass substrates according to the invention therefore comprise at least 2% of boron oxide, and advantageously at least 6%, or 8%, 9.5% and even 10%. Boron oxide contents that are too high however have a negative impact on the cost of the raw materials used and on the strain point. For these reasons, the boron oxide content must be less than or equal to 15%, and advantageously to 13%, or even 12%.

Alumina (Al₂O₃) makes it possible to increase the strain point and the Young's modulus. Its content is therefore advantageously greater than or equal to 12%, or even 14%. A high alumina content has, however, the disadvantage of greatly increasing the high-temperature viscosity and of decreasing the resistance to corrosion in an acid medium and the resistance of the glass to devitrification (especially by increasing the liquidus temperature). The alumina content of the glass according to the invention is therefore advantageously less than or equal to 22%, or 20% and even 18%. An alumina content between 14 and 15% constitutes a good compromise.

Lime (CaO) is essential for decreasing the high-temperature viscosity of the glass. Its content is therefore greater than or equal to 5%, preferably greater than or equal to 6%, or even 7% or 8%, and even 8.5%. Too high a content is, on the other hand, prejudicial to obtaining a low expansion coefficient. A content less than or equal to 10% is preferred. The glass according to the invention makes it possible to use a high CaO content, in particular strictly greater than 8%, without observing degradation of the resistance in acid medium, such as that which could be expected on reading the abovementioned patent U.S. Pat. No. 5,851,939.

According to one preferred embodiment that makes it possible to obtain a very good compromise between a high strain point and a low expansion coefficient, a boron oxide content greater than or equal to 11%, or even 12% and less than or equal to 13% is combined with a lime content less than or equal to 9% and greater than or equal to 6%, or even 7%.

Magnesia (MgO) is an optional component of the present invention. Its beneficial influence on the Young's modulus is unfortunately compensated for by a rapid degradation of the devitrification properties, expressed by an increase in the liquidus temperature and the crystallization rates. The MgO content is therefore preferably less than or equal to 2%, or less than 1% and even 0.5%. According to one preferred embodiment, the glass does not contain magnesium oxide, except for impurities that are difficult to avoid (less than 0.1%).

Barium oxide (BaO) and strontium oxide (SrO) have a deleterious influence on the density of the glass, which results in advantageously limiting the content of one and/or the other to 3% or less, especially 2%, or 1% or even 0.5% or 0.1%. The glass according to the invention advantageously does not contain strontium and/or barium oxides, except for inevitable impurities.

Zinc oxide (ZnO) is also advantageously absent from the glass compositions according to the invention, due to undesirable reactions when the glass sheet is produced by the “float” process, in which the glass is poured onto a molten tin bath under a reducing atmosphere. The reducing conditions necessary for avoiding oxidation of the tin bath result, specifically for glass that contains too high at content of ZnO, in a reduction of this metallic zinc oxide which forms a film on the glass sheet.

The glass according to the invention preferably does not contain zirconium, zinc, strontium and barium oxides.

Alkali metal oxides (R₂O collectively denoting these oxides, among which are found sodium, potassium and lithium oxides) must be limited to very low contents, preferably to less than 0.5% and even 0.1%, 0.05% or 0.01%. Zero amounts of alkali metal oxides (except for traces stemming from the raw materials) are greatly preferred. This is because the alkali metal oxides have a tendency to migrate to the surface of the glass and to considerably degrade the semiconducting properties of the silicon deposited on the substrate.

According to one preferred embodiment, the glass substrate according to the invention has a chemical composition comprising the following constituents, within the limits defined hereinbelow, expressed as weight percentages:

| SiO₂ | 60 to 70; |
|---|---|
| TiO₂ | 1.2 to 2; |
| B₂O₃ | 6 to 13; |
| Al₂O₃ | 12 to 18; |
| CaO | 5 to 10; |
| MgO | 0 to 3; |
| BaO, SrO, ZnO | <0.1; and |
| R₂O | <0.1. |

The glass substrates according to the invention may contain components other than those listed above. These may be refining agents, introduced intentionally, or other oxides, generally introduced unintentionally in the form of impurities and that do not substantially modify the manner in which the substrates according to the invention solve the technical problem in question. Generally, the content of impurities in the glass according to the invention is less than or equal to around 5% and even 3%, or even 2% or 1%.

The glass compositions according to the invention preferably comprise chemical agents intended to refine the glass, that is to say to remove gaseous inclusions contained in the bulk of the glass during the melting step. The refining agents used are, for example, arsenic or antimony oxides, halogens such as fluorine or chlorine, tin or cerium oxide, sulfates or a mixture of such compounds. The combination of tin oxide and chlorine has proved particularly effective and is therefore preferred within the context of the present invention. The compositions according to the invention do not advantageously contain arsenic or antimony oxides, due to their high toxicity.

The glass substrates according to the invention may also contain low amounts of other oxides such as zirconium oxide or oxides of rare-earth elements such as lanthanum or yttrium, but generally they do not contain them, except for traces stemming from impurities contained in the raw materials or stemming from the dissolution of elements contained in the constituent refractory materials of the glass melting furnace. In the case where the glass according to the invention contains zirconium oxide (ZrO₂), which may be used for further improving the Young's modulus, its content is not greater than 3%, or even 2%, as the liquidus temperature is strongly affected by the presence of this oxide.

The glass substrates according to the invention preferably have an expansion coefficient less than or equal to 35×10⁻⁷/° C., or even 33×10⁻⁷/° C. Their strain point is advantageously greater than or equal to 630° C., and even to 650° C. Due to the use of titanium oxide, the Young's modulus of the substrates according to the invention is generally greater than 70 GPa, or even 72 GPa. The temperature corresponding to the viscosity at which the glass is formed, i.e. around 10000 poise, this temperature being denoted by “T(log4)”, is preferably less than or equal to 1350° C.

Another subject of the invention is a continuous process for obtaining substrates according to the invention comprising the steps of melting, in a glass furnace, a glass batch of suitable composition, and of forming a glass sheet by pouring over a molten tin bath (float process). The melting temperature is advantageously below 1700° C., or even 1650° C.

A final subject of the invention is a flat screen, especially of the LCD (liquid crystal display) or OLED (organic light-emitting diode) type, comprising a glass substrate according to the invention.

The advantages of the invention are illustrated using the following nonlimiting examples, presented in tables 1 and 2.

The comparative example C1 is a glass representative of the teaching from Application WO 00/32528, close to examples 10 to 13 and 17 of this same application, and corresponding to an industrially produced LCD screen composition.

Examples 1 to 3 correspond to the teaching of the present invention.

Table 1 indicates, besides the chemical composition expressed in weight percentages, the following physical properties:
the Young's modulus, expressed in GPa, measured according to the standard ASTM C 1259-01;
the expansion coefficient between 25 and 300° C., measured according to the standard NF B30-103, expressed in 10⁻⁷/° C.;
the density (in g/cm⁻³), measured according to the so-called “Archimedes” method;
the strain point, expressed in ° C., approximately corresponding to the temperature at which the viscosity is equal to 10^{14.5} poise (10^{13.5} Pa·s), measured according to the standard NF B30-105;
the upper annealing temperature, known as “annealing point”, expressed in ° C., approximately corresponding to the temperature at which the viscosity is equal to 10¹³ poise (10¹² Pa·s), measured according to the standard NF B30-105;
the temperature at which the viscosity is 10⁴ poise (10³ Pa·s), denoted by T(log4), the latter being measured according to the standard ISO 7884-2 and approximately corresponding to the viscosity at which the glass is poured onto the molten metal bath during the float process; and
the optical transmission for a wavelength of 400 nm measured through a glass sample having a thickness of 1 mm.

TABLE 1

| | C1 | 1 | 2 | 3 |
|---|---|---|---|---|
| SiO₂ (wt %) | 64.5 | 64.3 | 63.8 | 64.4 |
| TiO₂ | — | 1.25 | 1.30 | 1.88 |
| B₂O₃ | 10.9 | 10.8 | 9.7 | 10.3 |
| Al₂O₃ | 16.2 | 16.2 | 16.3 | 16.1 |
| CaO | 8.4 | 7.5 | 8.5 | 7.4 |
| MgO | <0.1 | <0.1 | <0.1 | <0.1 |
| Young's modulus (GPa) | 69.9 | 72.1 | 71.9 | 73.0 |
| Expansion coeff. (10⁻⁷/° C.) | 31.3 | 31.3 | 31.1 | 30.4 |
| Density (g/cm³) | 2.37 | 2.35 | 2.37 | 2.35 |
| Strain Point (° C.) | 663 | 658 | 667 | 648 |
| Annealing point (° C.) | 721 | 717 | 725 | 706 |
| T(log4) (° C.) | 1320 | 1317 | 1315 | 1316 |
| Transmission at 400 nm(%) | 89.6 | | 87.7 | 85.6 |

The comparison between the examples according to the invention and the comparative example demonstrates the beneficial effect of titanium oxide on the increase of the Young's modulus, the other properties remaining largely unchanged.

Table 2 presents other examples of compositions according to the invention.

TABLE 2

| | 4 | 5 | 6 | 7 | 8 | 9 | 10 |
|---|---|---|---|---|---|---|---|
| SiO₂ | 65.6 | 64.6 | 63.6 | 63.1 | 65.7 | 61.3 | 59.3 |
| (wt %) | | | | | | | |
| TiO₂ | 1.05 | 2.1 | 0.85 | 1.40 | 1.27 | 1.30 | 1.30 |
| B₂O₃ | 12.0 | 13.0 | 11.0 | 10.0 | 10.4 | 8.1 | 8.1 |
| Al₂O₃ | 14.4 | 14.4 | 15.0 | 15.0 | 14.9 | 16.2 | 17.8 |
| CaO | 7.0 | 6.0 | 8.0 | 9.0 | 7.2 | 8.5 | 8.8 |
| MgO | <0.1 | <0.1 | 0.5 | 0.5 | <0.1 | 2.3 | 2.4 |
| BaO | | | 1.0 | | | | |
| SrO | | | | 1.0 | | 1.9 | 2.0 |
| Expansion | 33.1 | 33.4 | | | 28.2 | | 36.8 |
| coeff. | | | | | | | |
| (10⁻⁷/° C.) | | | | | | | |
| Strain | 650 | 650 | | | 649 | 652 | 665 |
| Point | | | | | | | |
| (° C.) | | | | | | | |
| T(log4) | 1320 | 1308 | | | 1316 | 1244 | |
| (° C.) | | | | | | | |

1: A glass substrate, characterized in that it has a chemical composition comprising the following constituents within the limits defined hereinbelow, expressed as weight percentages:
SiO₂ 58 to 72;
TiO₂ 0.8 to 3;
B₂O₃ 2 to 15;
Al₂O₃ 10 to 25;
CaO 5 to 12;
MgO 0 to 3;
BaO 0 to 6;
SrO 0 to 4;
ZnO 0 to 3; and
R₂O to 1,
R₂O denoting alkali metal oxides.

2: The glass substrate as claimed in claim 1, comprising titanium oxide (TiO₂) in a weight content between 1.2% and 2%.

3: The glass substrate as claimed in claim 1, comprising silicon oxide (SiO₂) in a weight content greater than or equal to 62%.

4: The glass substrate as claimed in claim 1, comprising boron oxide (B₂O₃) in a weight content greater than or equal to 9.5%.

5: The glass substrate as claimed in claim 1, comprising alumina (Al₂O₃) in a weight content between 12 and 18%.

6: The glass substrate as claimed in claim 1, comprising lime (CaO) in a weight content greater than or equal to 7%.

7: The glass substrate as claimed in claim 1, comprising lime (CaO) in a weight content between 7 and 9% and boron oxide (B₂O₃) in a content between 11 and 13%.

8: The glass substrate as claimed in claim 1, characterized in that it does not comprise magnesia (MgO).

9: The glass substrate as claimed in claim 1, comprising barium oxide (BaO) in a content that does not exceed 3%.

10: The glass substrate as claimed in claim 1, comprising strontium oxide (SrO) in a content that does not exceed 3%.

11: The glass substrate as claimed in claim 1, characterized in that it does not comprise barium oxide (BaO) and/or strontium oxide (SrO).

12: The glass substrate as claimed in claim 1, comprising cobalt oxide in a weight content between 5 and 50 ppm.

13: The glass substrate as claimed in claim 1, having a chemical composition comprising the following constituents, within the limits defined hereinbelow, expressed as weight percentages:

| SiO₂ | 60 to 70; |
|---|---|
| TiO₂ | 1.2 to 2; |
| B₂O₃ | 6 to 13; |
| Al₂O₃ | 12 to 18; |
| CaO | 5 to 10; |
| MgO | 0 to 3; |
| BaO, SrO, ZnO | <0.1; and |
| R₂O | <0.1. |

14: A continuous process for obtaining substrates as claimed in claim 1 comprising the steps of melting, in a glass furnace, a glass batch of suitable composition, and of forming a glass sheet by pouring over a molten tin bath.

15: A flat screen comprising a glass substrate as claimed in claim 1.
